(19) United States
(12) Patent Application Publication
(10) Pub. No.: US 2022/0364582 A1
(43) Pub. Date: Nov. 17, 2022

(54) FIBERS FOR REDUCING DRAG

(71) Applicant: UNIVERSITY OF NOTRE DAME, South Bend, IN (US)

(72) Inventors: Mitsugu Hasegawa, Notre Dame, IN (US); Hirotaka Sakaue, Notre Dame, IN (US)

(21) Appl. No.: 16/960,688

(22) PCT Filed: Jan. 8, 2019
(86) PCT No.: PCT/US2019/012630

§ 371 Date: Jul. 24, 2020

Related U.S. Application Data
(60) Provisional application No. 62/614,921, filed on Jan. 8, 2018.

(51) Int. Cl. F15D 1/00; F15D 1/12; F15D 1/06; B63B 5/24; B64C 1/00

(52) U.S. Cl. CPC F15D 1/003; F15D 1/12; F15D 1/06; B63B 5/24; B64C 1/0009; B63B 2005/242

(57) ABSTRACT

In one aspect of the present disclosure, a streamlined body for passing through a fluid is provided. The streamlined body includes an outer surface defining a leading edge and a trailing edge. The leading edge is oriented to pass through the fluid before the trailing edge during movement of the body through the fluid. The streamlined body further includes a plurality of fibers coupled to the outer surface. Each fiber of the plurality of fibers projects away from the outer surface.

### CROSS-REFERENCE TO RELATED APPLICATIONS

This application claims priority to U.S. Provisional Patent Application No. 62/614,921, filed with the United States Patent and Trademark Office on Jan. 8, 2018, the contents of which are incorporated by reference herein.

### STATEMENT REGARDING FEDERALLY-SPONSORED RESEARCH

This application was made with government support under grant FA-8650-15-C-2510 awarded by the Air Force Research Laboratory Information Directorate (AFRL/RI). The government has certain rights in the application.

### BACKGROUND

This application relates generally to technologies for reducing drag. More specifically, this application relates to a plurality of fibers applied to a surface to reduce drag forces.

Drag is a type of friction or fluid resistance based on fluid motion. Drag force is generally proportional to relative velocity for a laminar flow of a fluid and generally proportional to the squared relative velocity for a turbulent flow of a fluid. Form drag is the result of fluid resistance to motion due to the shape of an object moving relative to the fluid, while skin friction drag is the result of the interaction of a surface with the fluid as the surface moves relative to the fluid. These drag forces reduce the velocity of the fluid relative to the object or body with which the fluid interacts. To maintain a desired velocity of either the body moving through the fluid or the fluid moving past the body in spite of developed drag forces, more energy is required than would otherwise be needed in the absence of drag.

Industries and municipalities utilize pipelines to transport fluids for numerous purposes. Example fluids to be transported include water, oil, natural gas, heated or cooled air, waste water, slurries of various materials, and the like. Pumps are utilized in most scenarios to force the fluid through the pipeline. These pumps must overcome drag forces acting on the fluid within the piping system in order to maintain a desired flow rate of the fluid through the pipeline.

A significant percentage of the total U.S. Air Force budget is spent on jet fuel. Much of this jet fuel is used with regard to legacy aircraft operationally less fuel efficient than more modern aircraft. Much of the fuel inefficiency of these legacy aircraft can be attributed to the drag forces experienced as they move through the air. Consequently, legacy aircraft engines must consume more fuel than comparable newer aircraft engines in order to overcome these drag forces. Fuel consumption due to vehicle drag forces affects not only aircraft, but watercraft, land vehicles, and the like.

Wind forces also interfere with outdoor structures including utility poles, power lines, and the like. Buffeting due to turbulent air flow around these structures can cause unwanted movement and stresses.

### SUMMARY

Various aspects of the present disclosure are directed to a plurality of fibers applied to a surface subject to fluid interaction for reducing drag forces in a variety of applications.

In one aspect of the present disclosure, a pipe is provided. The pipe is utilized for transporting a fluid flow therethrough. The pipe includes an inner wall surface that defines an internal passageway of the pipe. The pipe further includes a plurality of fibers coupled to the inner wall surface. Each of the plurality of fibers projects away from the inner wall surface and into the internal passageway.

In another aspect of the present disclosure, a streamlined body is provided for passing through a fluid. The streamlined body includes an outer surface. The outer surface defines a leading edge and a trailing edge. The leading edge passes through the fluid before the trailing edge. The streamlined body further includes a plurality of fibers coupled to the outer surface. Each of the plurality of fibers projects away from the outer surface.

The foregoing summary is intended merely to provide a general overview of various aspects of the present disclosure, and is not intended to limit the scope of this application in any way.

### BRIEF DESCRIPTION OF THE DRAWINGS

These and other more detailed and specific features of various aspects of the present disclosure are more fully described in the following description, reference being had to the accompanying drawings, in which:

FIG. 1A schematically illustrates a longitudinal cross-sectional view of a pipe subject to fluid flow therethrough.

FIG. 1B schematically illustrates a longitudinal cross-sectional view of a pipe with a bend, the pipe subject to fluid flow therethrough.

FIG. 2A schematically illustrates a perspective view of a coating having a plurality of fibers.

FIG. 2B schematically illustrates a cross-sectional view of the coating taken along line 2B-2B of FIG. 2A.

FIG. 3 illustrates example fiber configurations.

FIG. 4A illustrates an example fiber cross-section.

FIG. 4B illustrates another example fiber cross-section.

FIG. 4C illustrates another example fiber cross-section.

FIG. 4D illustrates another example fiber cross-section.

FIG. 5A schematically illustrates an example fiber arrangement and orientation on a surface subject to fluid interaction.

FIG. 5B schematically illustrates another example fiber arrangement and orientation on a surface subject to fluid interaction.

FIG. 5C schematically illustrates another example fiber arrangement and orientation on a surface subject to fluid interaction.

FIG. 6A illustrates a partial cross-sectional view of a body having a plurality of fibers positioned on a portion of the body in a fluid flow stream.

FIG. 6B illustrates a partial cross-sectional view of another body having a plurality of fibers positioned on a portion of the body in a fluid flow stream.

FIG. 7A illustrates a cross-sectional view of another body having a plurality of fibers coupled to the outer surface of the body.

FIG. 7B illustrates a cross-sectional view of another body having a plurality of fibers coupled to a portion of the outer surface of the body.

FIG. 7C illustrates a cross-sectional view of another body having a plurality of fibers coupled to a portion of the outer surface of the body.

FIG. 8A illustrates a cross-sectional view of a streamlined body having a plurality of fibers coupled to a portion of the outer surface of the body.

FIG. 8B illustrates a top plan view of the streamlined body of FIG. 8A.

FIG. 9A illustrates a side elevation view of another streamlined body having a plurality of fibers coupled to a portion of the outer surface of the body, the body moving through a fluid.

FIG. 9B illustrates a side elevation view of another streamlined body having a plurality of fibers coupled to a portion of the outer surface of the body.

FIG. 9C illustrates a side elevation view of another streamlined body having a plurality of fibers coupled to a portion of the outer surface of the body.

FIG. 9D illustrates a side elevation view of another streamlined body having a plurality of fibers coupled to a portion of the outer surface of the body.

FIG. 9E illustrates a side elevation view of another streamlined body having a plurality of fibers coupled to a portion of the outer surface of the body.

FIG. 9F illustrates a side elevation view of another streamlined body having a plurality of fibers coupled to a portion of the outer surface of the body.

### DETAILED DESCRIPTION

It will be apparent to one skilled in the art that the specific details set forth in the following description are merely exemplary and explanatory, and are not intended to limit the scope of this application. The disclosure is capable of supporting other implementations and of being practiced or of being carried out in various ways.

A passive drag reduction technique requires no ongoing additional energy consumption to reduce drag. One passive drag reduction technique applicable to a pipe transporting a fluid flow is to apply a plurality of fibers to all or portions of the inner wall surface of the pipe's internal passageway.

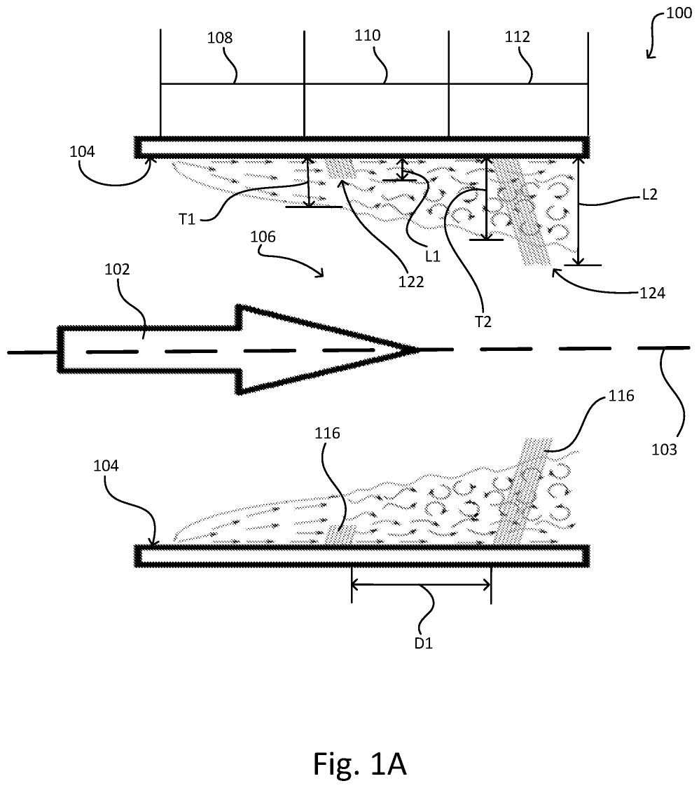

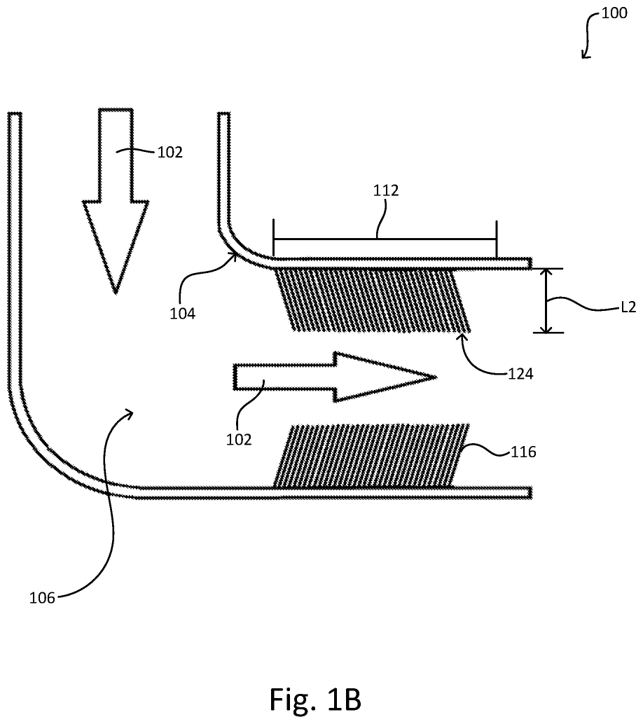

FIG. 1A schematically illustrates a straight pipe 100 for transporting a fluid flow 102 therethrough. The fluid flow 102 may generally move along the length of the pipe 100, which is defined as the dimension of the pipe extending along the longitudinal axis 103 of the pipe. The fluid flow 102 may be a flow of any appropriate fluid including, for instance, water, oil, natural gas, heated or cooled air, waste water, slurries of various materials, and the like. The pipe 100 includes an inner wall surface 104, which defines an internal passageway 106 of the pipe. For purposes of illustrating the development of a flow boundary layer, the pipe 100 is subjected to the fluid flow 102 at a position sufficiently upstream to provide a developed flow profile. The fluid flow 102 may therefore include a laminar flow section 108, a transitional flow section 110, and a turbulent flow section 112 as the fluid flow moves along the inner wall surface 104 of the pipe 100 and in accordance with conventional boundary layer theory known to those of skill in the art.

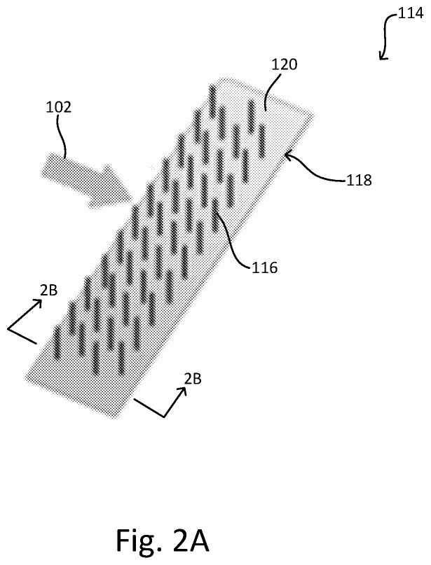

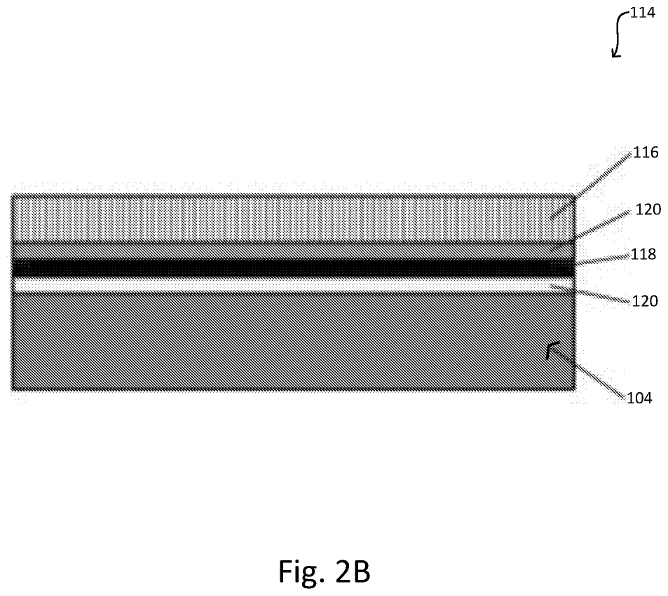

A plurality of fibers 116 is applied to the inner wall surface 104. Some embodiments of applying the plurality of fibers 116 on the inner wall surface 104 include applying a coating 114, such as that illustrated schematically in FIGS. 2A and 2B. In some embodiments, the coating 114 is in the form of a tape 118 with one or more adhesive layers 120 provided on the tape 118. Other embodiments of producing the plurality of fibers 116 on the inner wall surface 104 include deposition of the fibers directly onto the inner wall surface.

With reference to FIG. 1B, a pipe 100 having a bend is contemplated herein. In such embodiments, the plurality of fibers 116 are positioned after the bend in the pipe 100. The fluid flow 102 passes through the internal passageway 106 through the bend in the pipe 100 and continues downstream into a relatively straight section of the pipe. This change in direction can cause considerable turbulence in the fluid flow 102. The internal passageway 106 of the pipe 100 downstream from the bend is consequently, depending on the characteristics of the fluid, subject to turbulent flow for a distance 112. In this region, the plurality of fibers 116 are positioned to attenuate the turbulence of the fluid flow 102.

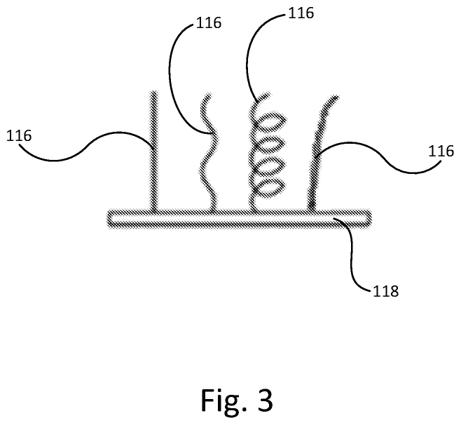

Referring now to FIG. 3, example configurations of the fibers 116 are shown. The fibers 116 may be arranged in any appropriate shape and/or position relative to the inner wall surface 104 of the pipe and, additionally or alternatively, the coating 114. Some non-limiting examples shown include a fiber 116 that is completely straight, wavy, curly, or curved. Other non-limiting examples include a fiber 116 that is partially shaped in, for instance, any of the above ways. Still other non-limiting examples include a fiber 116 that is a combination of two or more shapes such as, for instance, those discussed above.

Each of these and other configurations for the fibers 116 may include rigid or flexible fibers in part or whole. The rigidity of the fibers 116 may be adjusted by selecting a particular material of the fibers, adjusting a density of the material, adjusting a thickness of each fiber, and the like. Thicker fibers 116 and/or fibers made from materials such as nylon or polyester rather than cotton or rayon may be used to exhibit relatively increased rigidity. Fibers 116 should be more rigid for applications including relatively viscous fluids, such as water, oil, waste, slurries, and the like than fibers for applications including fluids such as air. In one exemplary embodiment, the fibers 116 are flexible enough to be directed by combing or other surface treatment of the fibers a part of additional fiber treatment steps after fiber deposition.

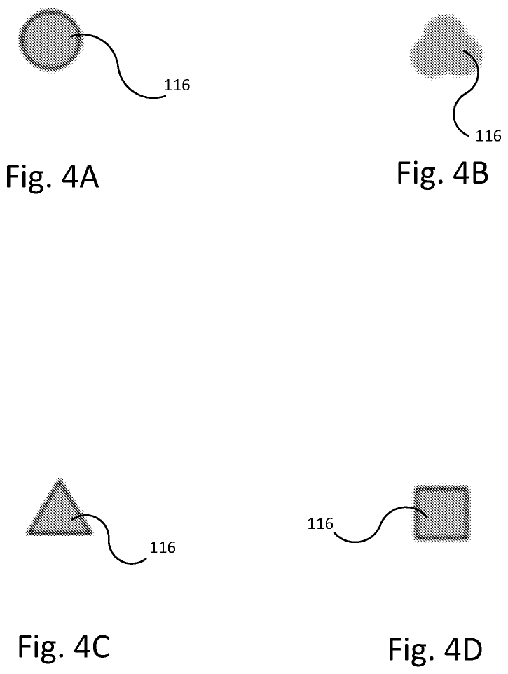

As illustrated in FIGS. 4A-4D, each fiber may have any appropriate cross-sectional shape. Some non-limiting examples shown include fibers 116 with a circular cross-section, a cross-section made of multiple intersecting circles, a triangular cross-section, and a rectangular cross-section. Other non-illustrated cross-sections, such as hexagonal and the like, are also contemplated herein. One particular exemplary embodiment includes fibers 116 with a circular cross-section having a diameter of less than or equal to 50 μm. This diameter may correspond with flexible fibers 116, while a relatively rigid fiber may include a diameter that is two or three times greater. The fibers 116 of a given coating 114 or of a given collection of fibers may all have the same uniform cross-section or may have cross-sections that vary in size and/or shape. The fibers 116 may be made of any appropriate material including, for instance, nylon, polyester, rayon, cotton, some combination thereof, and the like.

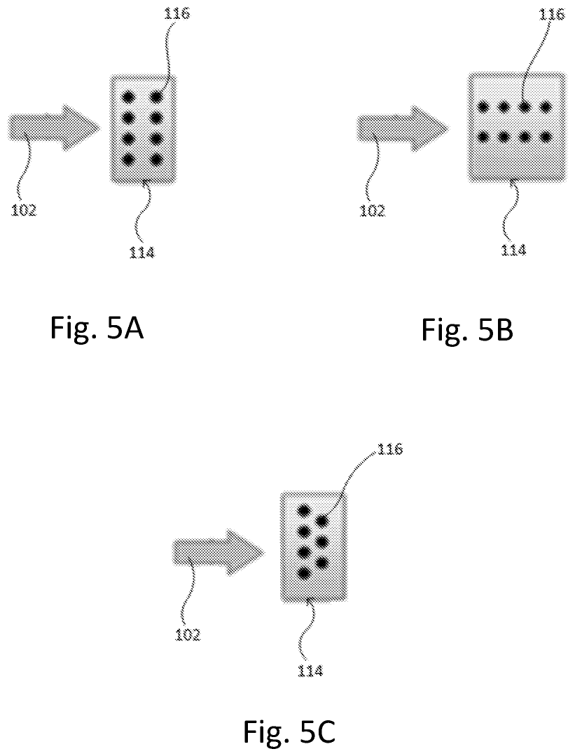

With reference to FIGS. 5A-5C, the coating 114 includes the fibers 116 positioned or oriented in any appropriate manner relative to the fluid flow 102. Some non-limiting examples shown include fibers 116 arranged in rows extending generally perpendicular to the direction of the fluid flow 102, arranged in rows extending generally parallel to the direction of the fluid flow, and arranged in an offset or diagonal pattern. Other non-illustrated arrangements, such as curved or wavy fiber alignment patterns, are also contemplated herein. The entire coating 114 may have a uniformly spaced arrangement of fibers 116, or the fibers may be arranged in a varied or even random pattern. Other non-illustrated shapes or positions of the fibers 116 may include an interwoven pattern of the fibers such as, for example, a tangled layer of fibers.

In some embodiments, the coating 114 is manufactured by covering a foil tape 118 with one or more of the adhesive layers 120, such as an epoxy layer, provided on a side of the tape such that the plurality of fibers 116 easily couple to the tape. A voltage is applied to the foil tape 118 effective to provide an electrostatic field over the foil tape. The fibers 116, such as nylon fibers, are attracted to and forced to move by the electrostatic field. Then, the fibers 116 are embedded into the adhesive layer 120 on the foil tape 118. This method allows for fibers 116 that extend generally perpendicular to the surface of the tape 118. The foil tape 118 may be adjusted in angle relative to the incoming fibers 116 to affect the deposition angle of the fibers on the tape. In some embodiments, the fibers 116 are deposited on the foil tape 118 in a swept-back orientation with the fibers being angled less than 90° and greater than 0° relative to the tape. Another adhesive layer 120 is provided on a side of the tape 118 opposite the side coupled to the fibers 116 such that the tape may be affixed to a desired surface (such as the inner wall surface 104 of the pipe 100).

The coating 114 may be taped on a desired surface, such as the inner wall surface 104 of the pipe 100, or it may be embedded into a layer, such as a sealant or paint layer, of the pipe. In an embedded embodiment, one of the adhesive layers 120 may be omitted. Alternatively, the fibers 116 may be directly applied to the pipe without a coating through direct deposition via one or more molds, a spray device, and the like.

In some direct fiber application embodiments, the plurality of fibers 116 may be in liquid form prior to deposition on the inner wall surface 104 (or onto the tape 118). The molten ends of each section of material that will become a fiber 116 may dry onto the inner wall surface 104 (or onto the tape 118), thereby coupling the fibers without an adhesive. The molds, for instance, may be shaped such that the fibers 116 produced are of any shape and orientation as those discussed above. Polyester is a non-limiting example of an appropriate material for the fibers 116 in some direct fiber application embodiments.

Returning now to FIGS. 1A and 1B, in operation during a fluid flow event, the fibers 116 constrain and absorb developing eddies in the fluid flow 102 to inhibit the development of relatively large eddies. The constraint of developing eddies allows for a passive reduction in skin friction by turbulence control through delaying growth of the turbulent flow section 112. The fibers 116 are either directly or indirectly coupled to the inner wall surface 104 of the pipe 100. Each of the fibers 116 projects away from the inner wall surface 104 and into the internal passageway 106 of the pipe 100. In the schematic illustrations shown, the fibers 116 are substantially parallel to each other as they extend into the internal passageway 106.

The plurality of fibers 116 can be tailored for a specific application by adjusting at least one of the diameter, length, direction of extension, elasticity, cross-section, surface finish, composition, and the like of the fibers. Some example lengths for the fibers 116 include, but are not limited to, 0.5 mm, 1.0 mm, 1.5 mm, 2.5 mm, and 4.0 mm. The arrangement and density of the fibers 116 can also be adjusted as needed. In some embodiments, the density of the fibers 116 can be varied corresponding to the selected length of the fibers. As such, some embodiments include, for instance, 84 fibers per mm² with fibers that are 0.5 mm long, 60 fibers per mm² with fibers that are 1.0 mm long, 14 fibers per mm² with fibers that are 1.5 mm long, 6 fibers per mm² with fibers that are 2.5 mm long, 4 fibers per mm² with fibers that are 4.0 mm long, and the like.

The fibers 116 cover the entire inner wall surface 104 of the pipe 100 in some embodiments. In other embodiments, discrete sections of fibers 116 are separated by a discontinuity distance D1 (FIG. 1A). In the illustrated embodiment, the discrete sections of fibers 116 are separated by the discontinuity distance D1 in a direction extending along the length of the pipe 100. Additionally or alternatively, the discrete sections of fibers 116 can be separated along a circumference of a pipe 100 having a circular cross-section (i.e., different arc lengths of sections of fibers and spacings or discontinuities between sections of fibers). In some embodiments, one or more sections of fibers 116 can be placed only in critical locations along the pipe 100 corresponding to unique characteristics of the fluid flow 102. Some of these locations may include, for instance, the transitional flow section 110 of the pipe 100, the turbulent flow section 112 of the pipe, and the like. Such selective application of the fibers 116 can save on costs and/or labor in manufacturing the pipe 100.

As shown in FIG. 1A, some embodiments of the pipe 100 include a section of fibers 116 having a length L1 that is shorter than the boundary layer thickness T1 of the fluid flow. For instance, the fibers 116 include a section of short fibers 122 having a length L1 of less than or equal to 0.5 mm. The section of short fibers 122 is shown positioned in the transitional flow section 110 of the fluid flow 102 and have a length L1 that is shorter than the boundary layer thickness T1 in the transitional flow section. These fibers 116 in the section of short fibers 122 are arranged such that they constrain the development of eddies in the transitional flow section 110 and, therefore, delay the development of the turbulent flow section 112.

Also as shown in FIG. 1A, some embodiments of the pipe 100 include a section of fibers 116 having a length L2 that is longer than the boundary layer thickness T2 of the fluid flow. For instance, the fibers 116 include a section of long fibers 124 having a length L2 of less than or equal to 4.0 mm. The fibers 116 in the section of long fibers 124 further have a length L2 of greater than 0.5 mm. This section of long fibers 124 is positioned sufficiently downstream in the internal passageway 106 of the pipe 100 such that it is located in the turbulent section 112 of the fluid flow 102. These fibers 116 in the section of long fibers 124 absorb eddies in the turbulent flow section 112 to control flow separation of the fluid flow 102.

In the embodiment schematically illustrated in FIG. 1A, the section of short fibers 122 is positioned upstream of the section of long fibers 124, and the sections are separated by the discontinuity distance D1. In other embodiments, the inner wall surface 104 at the position of the illustrated discontinuity distance D1 may instead be occupied with additional sections of short fibers 122 or may be occupied with a section of fibers 116 that progressively increase in length from the length L1 of the section of short fibers 122 to the length L2 of the section of long fibers 124.

In the embodiment schematically illustrated in FIG. 1B, only a section of long fibers 124 is provided because the fluid flow 102 is already in a turbulent section 112 due to the bend in the pipe 100 upstream of the fibers 116.

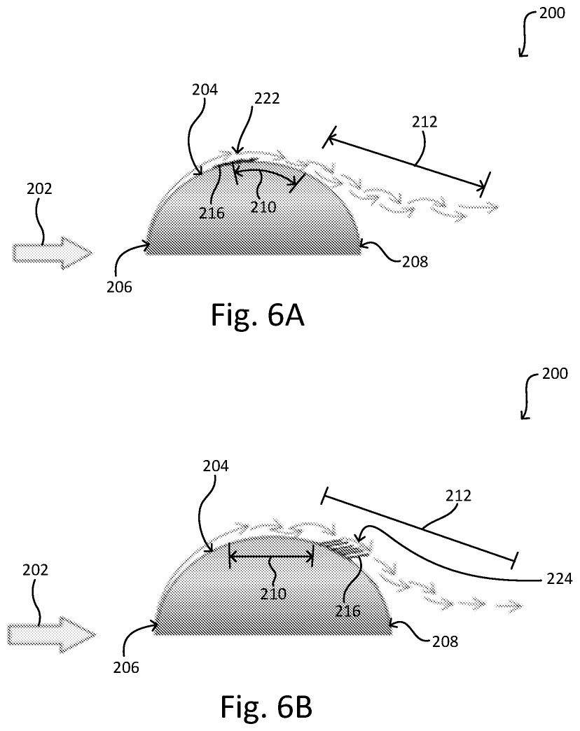

Referring now to FIGS. 6A and 6B, a streamlined body 200 for passing through a fluid 202 is schematically shown. The streamlined body 200 may be a hydrodynamic and/or aerodynamic body, and the fluid, as such, may be any appropriate fluid including water, air, and the like. The streamlined body 200 may be a portion or component of any appropriate aircraft (such as an airfoil or a portion thereof), watercraft (ship or undersea vessel), land vehicle (including commercial trucks), outdoor structure (such as a pole, building, or wind turbine), underwater structure, utility line, sensor (with or without mounting post), sportswear (such as helmets and clothing), sports vehicles (such as bobsleds and racing cars), and the like, all of which are represented schematically in FIGS. 6A-9E.

The streamlined body 200 includes an outer surface 204. The outer surface 204 defines a leading edge 206 and a trailing edge 208. The leading edge 206 is positioned to pass through the fluid 202 before the trailing edge 208 passes through the fluid. Stated another way, the leading edge 206 leads, or is forward or upstream from, the trailing edge 208.

A plurality of fibers 216, with or without a coating as discussed above, are coupled to the outer surface 204 in any appropriate manner. For instance, the coating 214 may be taped on a desired portion of the outer surface 204, embedded into a layer, such as a sealant or paint layer, of the outer surface, or deposited directly onto the outer surface in a manner similar to those discussed above. Each of the fibers 216, once affixed, projects away from the outer surface 204. Also as discussed above (with regard to the fibers 116), the fibers 216 may be arranged in a variety of configurations. Further, the fibers 216 may be made of any appropriate material including, for instance, nylon, rayon, cotton, or polyester.

As shown in FIG. 6A, some embodiments of the streamlined body 200 include the fibers 216 covering a portion of the outer surface 204 nearer the leading edge 206 than the trailing edge 208. In such embodiments, the fibers 216 may be a section of short fibers 222 with each fiber having a fiber length L1 of less than or equal to 1.7 mm. Further embodiments may include the short fibers 222 having a fiber length L1 of less than or equal to 0.5 mm. The fibers 216 are shown laid down due to the flow of the fluid 202 past the streamlined body 200. Of course, the fibers 216 may instead be constructed to be laid down or swept back even without the influence of the flow of the fluid 202. As discussed above, the fibers 216 may be flexible or elastic in some embodiments. The short fibers 222 are arranged such that they constrain the development of eddies in the transitional flow section 210 and, therefore, delay the development of the turbulent flow section 212.

As shown in FIG. 6B, some embodiments of the streamlined body 200 include the fibers 216 covering a portion of the outer surface 204 nearer the trailing edge 208 than the leading edge 206. In such embodiments, the fibers 216 may be a section of long fibers 224 with each fiber having a fiber length L2 less than or equal to 10.0 mm. Further embodiments may include the long fibers 224 having a fiber length L2 of less than or equal to 4.0 mm. The fibers 216 are shown swept back due to the flow of the fluid 202 past the streamlined body 200, but may instead be manufactured in such an orientation without the influence of fluid flow. The long fibers 224 absorb eddies in the turbulent flow section 212 to minimize turbulence of the fluid 202 as it continues after the streamlined body 200.

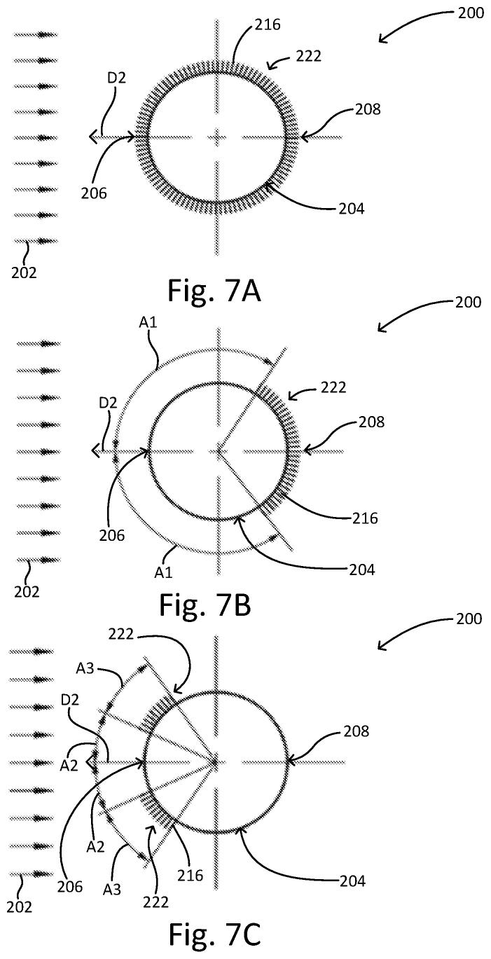

Turning now to FIGS. 7A, 7B, and 7C, other potential arrangements of the fibers 216 on the streamlined body 200 are shown. With regard to FIG. 7A, some embodiments of the streamlined body 200 include the fibers 216 covering the entirety of the outer surface 204. The fibers 216 of the streamlined body 200 in FIG. 7A may all be short fibers 222, for instance. The outer surface 204 entirely covered with the coating 214 does not suffer from direction dependence with regard to the flow of the fluid 202 past the streamlined body 200.

FIG. 7B illustrates an embodiment of the streamlined body 200 having the fibers 216 covering a portion of the outer surface 204 nearer the trailing edge 208 than the leading edge 206. In this illustrated embodiment, the fibers 216 are set back by an angle A1 from the direction of travel D2 of the streamlined body 200. The fibers 216 of the streamlined body 200 in FIG. 7B may all be long fibers 224, for instance.

With regard to FIG. 7C, some embodiments of the streamlined body 200 include the fibers 216 covering separate portions of the outer surface 204 with two discrete sections of the fibers. The two sections of the fibers 216 may both be nearer the leading edge 206 than the trailing edge 208 and may be set back by an angle A2 from the direction of travel D2 of the streamlined body 200. The two sections of the fibers 216 may be set back the same angle A2 or may be set back at different angles. Each of the two sections of the fibers 216 may continue through a coverage angle A3 that is less 90° about the streamlined body 200. In this illustrated embodiment, the fibers 216 may all be short fibers 222, for instance.

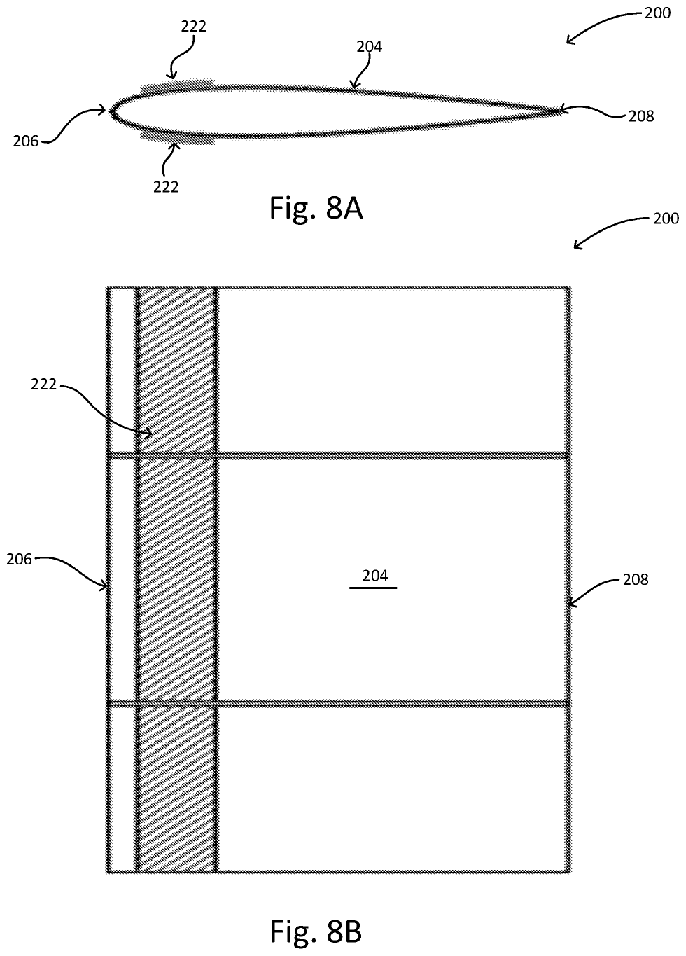

Turning now to FIGS. 8A and 8B, the streamlined body 200 may be in the form of an airfoil. For purposes of discussion herein, the length of the airfoil streamlined body 200 may be considered the dimension of the airfoil extending from the leading edge 206 to the trailing edge 208. In FIGS. 8A and 8B, the airfoil streamlined body 200 includes two discrete sections of the fibers 216 in a manner similar to that described with regard to FIG. 7C above. As stated above, the fibers 216 may include all short fibers 222 in such an embodiment. Of course, many other configurations and arrangements of fibers 216 with regard to an airfoil streamlined body 200 are contemplated herein.

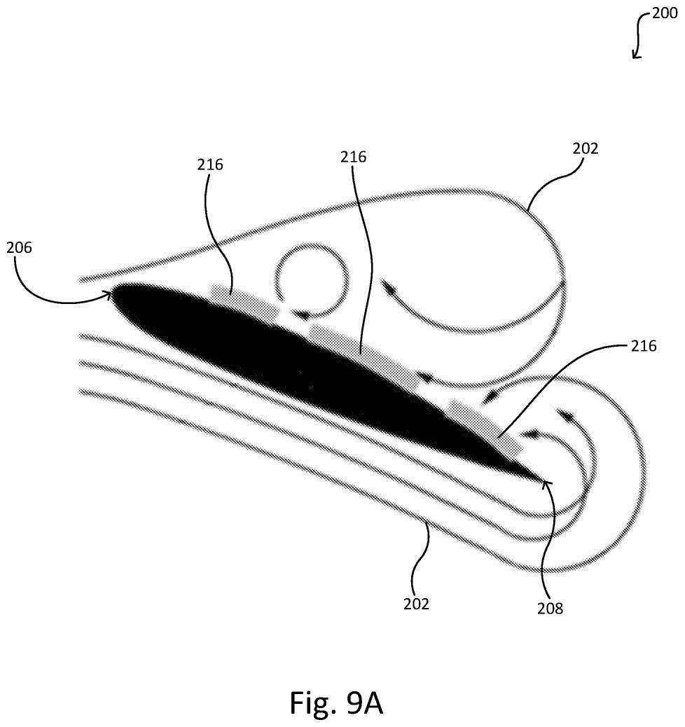

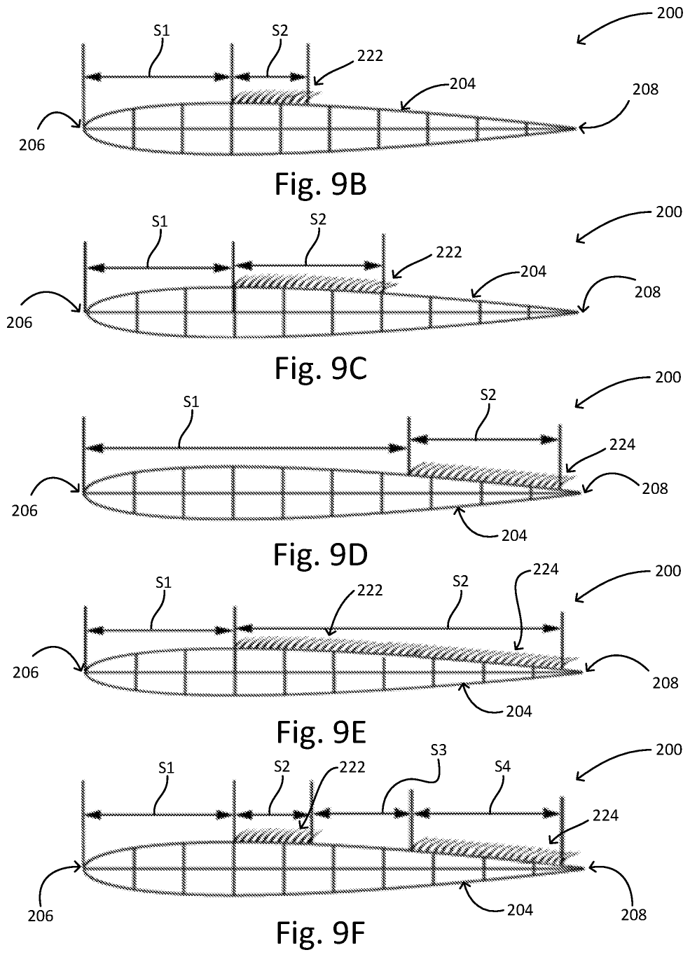

FIGS. 9A-9F show examples of an airfoil streamlined body 200 that includes one or more sections of fibers 216 to reduce the skin friction coefficient in a transitional or turbulent fluid flow area. It should be understood that such a streamlined body 200, although described with regard to air, may also be applicable in water or other fluids. The skin friction coefficient is reduced by minimizing the flow separation with the fibers 216 through attenuating eddies in the fluid flow. It is recognized herein that the angle of attack of the streamlined body 200 with regard to the fluid flow can have an effect on the efficacy of the fibers 216 in reducing skin friction coefficient. The greater the angle of attack, that is, the more the streamlined body 200 is positioned with the leading edge 206 higher than the trailing edge 208 in a direction perpendicular to the fluid flow, the more effective the fibers 216 may be. The airfoil streamlined body 200 in FIG. 9A is shown with the leading edge 206 extending above the trailing edge 208 at an angle of attack of between about 20° and about 30° relative to the horizontal flow of the fluid 202. The airfoil streamlined body 200 is shown in FIGS. 9B-9E in a generally horizontal position, which would have the angle of attack at about 0°. As the airflow moves from left to right on the Figures, the angle of attack is greater as the airfoil streamlined body 200 is rotated clockwise on the page as shown.

As shown in FIG. 9B, the airfoil streamlined body 200 may include a section of fibers 216 that covers a portion of the middle third of the length of the airfoil. The fibers 216 may be set back from the leading edge 206 by a fiberless first section S1. This first section S1 may be approximately one third of the length of the airfoil streamlined body 200 in some embodiments. The fibers 216 may extend along the length of the airfoil streamlined body 200 to form a coverage section S2. The coverage section S2 may be less than approximately one third of the length of the airfoil streamlined body 200 in some embodiments. The fibers 216 may be short fibers 222 or any other appropriate length.

With regard to FIG. 9C, the airfoil streamlined body 200 may be similar to that described above for FIG. 9B. The airfoil streamlined body 200 of FIG. 9C, however, may include the coverage section S2 forming approximately one third of the length of the airfoil streamlined body 200. The fibers 216 may be short fibers 222 or any other appropriate length.

In the embodiment shown in FIG. 9D, the fiberless first section S1 extends approximately two thirds of the length of the airfoil streamlined body 200. The coverage section S2 forms the remaining approximately one third of the length of the airfoil streamlined body 200. The fibers 216 may be long fibers 224 or any other appropriate length.

The embodiment shown in FIG. 9E includes a fiberless first section S1 extending approximately one third of the length of the airfoil streamlined body 200. The coverage section S2 extends the remaining approximately two thirds of the length of the airfoil streamlined body 200. The coverage section S2 in this embodiment may include fibers 216 that gradually change from short fibers 222 to long fibers 224 as they progress away from the leading edge 206 toward the trailing edge 208 of the airfoil streamlined body 200.

FIG. 9F shows yet another embodiment of an airfoil streamlined body 200. The airfoil streamlined body 200 of this embodiment includes a fiberless first section S1 extending approximately one third of the length of the airfoil. The airfoil streamlined body 200 in FIG. 9F includes two discrete sections of the fibers 216 in the form of a forward coverage section S2 and a rearward coverage section S4. The two coverage sections S2, S4 are separated by a fiberless second section S3. In the exemplary embodiment shown in FIG. 9F, the forward coverage section S2 and the fiberless second section S3 make up approximately one third of the length of the airfoil streamlined body 200. The rearward coverage section S4 extends the remaining one third of the length of the airfoil streamlined body 200. In such an embodiment, the forward coverage section S2 includes a section of short fibers 222 and the rearward coverage section S4 includes a section of long fibers 224.

Although the embodiments of FIGS. 9B-9E were discussed with regard to the length of the airfoil streamlined body 200 divided into thirds, it should be understood that these embodiments are non-limiting. Other embodiments may include one or more fiberless sections S1, S3 that are greater than or less than one third of the length of the airfoil streamlined body 200 and may include one or more coverage sections S2, S4 that are greater than or less than one third of the length of the airfoil. Some exemplary embodiments include each coverage section S2, S4 covering 10-20%, 15%, 25-25%, 30%, 55-65%, or 60% of the length of the airfoil streamlined body 200.

Thus, various embodiments including fibers applied to a surface to reduce drag have been described. While the above describes example embodiments of the present disclosure, these descriptions should not be viewed in a limiting sense. Rather, there are several variations and modifications which may be made without departing from the scope of the present disclosure.

1-35. (canceled)

36. A streamlined body for passing through a fluid, the streamlined body comprising:
an outer surface defining a leading edge and a trailing edge, the leading edge oriented to pass through the fluid before the trailing edge during movement of the body through the fluid; and
a plurality of fibers coupled to the outer surface, each fiber of the plurality of fibers projecting away from the outer surface.

37. The streamlined body of claim 36, wherein each fiber of the plurality of fibers is constructed of nylon, cotton, rayon, or polyester.

38. The streamlined body of claim 36, wherein the plurality of fibers is positioned on a portion of the outer surface nearer the leading edge than the trailing edge.

39. The streamlined body of claim 38, wherein each fiber of the plurality of fibers has a fiber length of less than or equal to 1.7 mm.

40. The streamlined body of claim 36, wherein the plurality of fibers is positioned on the outer surface with at least two discrete sections of the plurality of fibers, one section of the at least two discrete sections is nearer the leading edge than another of the at least two discrete sections, and the one section nearer the leading edge has shorter fibers than the other section.

41. The streamlined body of claim 36, wherein the plurality of fibers is positioned on a portion of the outer surface nearer the trailing edge than the leading edge.

42. The streamlined body of claim 41, wherein each fiber of the plurality of fibers has a fiber length of less than or equal to 10.0 mm.

43. The streamlined body of claim 36, wherein the streamlined body is a portion of an aircraft, a portion of a land vehicle, a portion of a ship, a portion of an underwater vessel, or a portion of a wind turbine.

44. The streamlined body of claim 36, wherein the streamlined body is substantially cylindrical in cross-section.

45. The streamlined body of claim 44, wherein the streamlined body is a wire, a pole, a portion of a garment to be worn by a user, or a portion of an antenna.

46. A pipe for transporting a fluid flow therethrough, the pipe comprising:
an inner wall surface defining an internal passageway of the pipe; and
a plurality of fibers coupled to the inner wall surface, at least some fibers of the plurality of fibers projecting away from the inner wall surface and into the internal passageway.

47. The pipe of claim 46, wherein the at least some fibers are of a length selected to exceed a boundary layer thickness of the fluid flow to be passed through the pipe.

48. The pipe of claim 46, wherein the at least some fibers are positioned sufficiently downstream in the internal passageway to be located in a turbulent section of the fluid flow to be passed through the pipe.

49. The pipe of claim 46, wherein the at least some fibers have a fiber diameter of less than or equal to 50 μm and a fiber length of less than or equal to 4.0 mm.

50. The pipe of claim 46, wherein the at least some fibers include a plurality of short fibers and a plurality of long fibers, the plurality of short fibers positioned upstream of the plurality of long fibers.

51. The pipe of claim 50, wherein the plurality of short fibers are separated from the plurality of long fibers by a discontinuity distance extending along a length of the pipe.

52. The pipe of claim 50, wherein each fiber of the plurality of short fibers has a fiber length of less than or equal to 0.5 mm and each fiber of the plurality of long fibers has a fiber length of greater than 0.5 mm and less than or equal to 4.0 mm.

53. The pipe of claim 46, wherein each fiber of the plurality of fibers is constructed of nylon, cotton, rayon, or polyester.

54. The pipe of claim 46, wherein the pipe forms an air duct for an HVAC system.

55. The pipe of claim 46, wherein the plurality of fibers is coupled to the inner wall downstream from a bend in the pipe.
